(19) United States
(12) Patent Application Publication
(10) Pub. No.: US 2003/0162892 A1
(43) Pub. Date: Aug. 28, 2003

(54) Coating system for veneered wood based on polyurethane dispersions method for the production and use thereof

(76) Inventors: Alois Maier, Engelsberg (DE); Stefan Ingrisch, Seebruck (DE); Alfred Kern, Kirchweidach (DE); Christian Huber, Trostberg (DE); Sascha Raspl, Garching (DE); Wolfgang Hiller, Tubingen (DE); Rupert Stadler, Mindelheim (DE)

Correspondence Address: FULBRIGHT & JAWORSKI, LLP, 666 FIFTH AVE, NEW YORK, NY, 10103-3198, US

(21) Appl. No.: 10/332,743

(22) PCT Filed: Aug. 8, 2001
(86) PCT No.: PCT/EP01/09177

(30) Foreign Application Priority Data
Aug. 9, 2000 (DE) 100 38 958.9

(51) Int. Cl. C08L 75/00

(52) U.S. Cl. 524/839; 524/871

(57) ABSTRACT

A flexible and/or postformable coating system for veneered wood and further coating materials based on at least one polyurethane dispersion is described, which is obtainable by reacting

a) 25 to 250 parts by weight of a polyol component (A),

b) 50 to 250 parts by weight of a polyisocyanate component (B),

c) 2 to 50 parts by weight of a polyamine component (C),

d) 0 to 100 parts by weight of a solvent component (D),

e) 50 to 1500 parts by weight of water to give a solvent-free or low-solvent polyurethane dispersion and then further processing this by adding

f) if required, 0.5 to 50 parts by weight of a photoinitiator component (E) and

g) 0.5 to 500 parts by weight of a formulation component (F) to give the end product.

By using the coating system according to the invention and based on (radiation-curable) polyurethane dispersions, not only can the production of industrially coated shaped articles and finished products be significantly simplified but also a plaster effect is achieved in the postforming method by plastifying the veneer or coating material, which effect, depending on the formability of the veneer or coating material, permits small bending radii and dispenses with the need for steam treatment or moistening.

The present invention relates to a flexible and/or postformable coating system for veneered wood and further coating materials based on polyurethane dispersions, a method for its production and its use.

The direct postforming method for melamine-coated woodbase material laminate boards has long been a part of the prior art. Further developments of the method and innovations in the tool and machine sector now also permit the production of veneered boards in the direct postforming method. The polycrystalline diamond (PCD) cutting material makes an important contribution.

Veneers are wood layers produced from solid wood by various cutting methods and having a thickness of 0.3 to 10 mm. The thinner decorative top veneers (“face veneers”) are glued over one or both surfaces of the blank material to be concealed (woodbase materials, e.g. particle boards or hard fiber boards and the like) and thus impart the impression of solid wood. The term “veneered wood” therefore designates laminates of veneer and woodbase materials.

The further development of the multistage postforming method to the direct postforming method led at Homag Maschinenbau AG in Schopfloch to the construction of machines which are specially suitable for this purpose and are adapted to the use of veneer instead of customary laminates. They ensure, inter alia, simpler handling of the boards to be processed, faster and simpler production sequences and the omission of intermediate storage.

The production of a postforming element takes place in one operation. The cutting is effected in a plurality of steps using a plurality of PCD tools. In a first step, the corresponding edge region of the baseboard is cut away to a residual amount of about 3 mm. In the next operation, a PCD combination tool having a diameter of 250 mm removes the remaining material down to the veneer and precuts the profile radius from below at the transition from the baseboard to the coating. The processing must be carried out synchronously since otherwise the veneer fiber may be gripped by the tool and the veneer damaged.

Of particular importance for the subsequent glue absorption is the picking out of the workpiece at the transition from the baseboard to the coating. If a tool having a width of 1.75 mm is usually used, a specially developed PCD tool having a substantially reduced tool width is employed in the case of veneered elements. The processing is effected at 9000 rpm, it being possible to choose the cutting depth as a function of the profile radius. The feed speed is generally chosen between 14 and 25 m/min in all operations. In spite of the high sidewall load and the associated high thermal stress of the cutting edges, the tool life travel corresponds to a cut length of 25000 linear meters. Cutting is completed by the use of a PCD laminating tool by means of which the top layer is cut away, and with the use of a further radius and profile cutter for cutting the upper profile edge.

In a final adhesive application unit of the machine, a bead of hotmelt adhesive is applied in the lower radius region of the processing edge, at the transition between particle board and veneer. In contrast to the otherwise customary PVAc adhesive which, owing to the high water content, leads to cracking during drying in the case of veneer, EVA/PO hotmelt adhesives are used. Through the use of a specially developed wetting apparatus, the veneer fiber is pretreated in order to achieve forming without back lamination. The use of slotted dies during glue application makes it possible to realize even difficult profile geometries. After the glue application, the veneer is activated and aerated. In the downstream pressure zone, the projecting veneer is formed and is pressed onto the profiled particle board. Pressure shoes are used in combination with rollers. A finishing unit forms the final part of the “direct postforming machine”.

After the direct postforming method, the veneered particle boards are thus formatted and postformatted while clamped during passage through the machine.

Description of Method

1. Adhesives for laminating the veneer with the particle board:

The adhesive used for adhesive bonding over the surface has the following function:

a) The adhesive prevents the penetration of externally applied moisture to the inside. This ensures good wetting of the hotmelt adhesive applied with the glue roll.

b) The adhesive supports the cohesion of open-pore veneers.

The adhesive used is urea glue with max. 20% of PVAC additive.

The amount of glue applied is about 100-120 g·m⁻². During pressing of the surfaces, it must be ensured that the glue penetration (glue which penetrates through the veneer to the surface) is as small as possible.

2. Cutting of the particle board to the correct veneer thickness:

The veneer is face cut from below by about 0.1 mm to a veneer thickness of about 0.6 mm.

Reason

Cutting off the penetrated glue

Roughening the veneer for better wetting

Reducing the surface tension

Constant veneer thickness throughout

3. Achieving the suitable moisture level for profiling the boards and forming the veneer:

a) During profiling of the coated boards, the veneer should have a moisture content of about 8% to avoid splintering. A moisture content which is too high is disadvantageous since the veneer tends to “rise” owing to internal stress (i.e. moisture difference between inside and outside) and is gripped by the blade during cutting and then torn off.

b) A veneer moisture content of about 12% is required for forming the veneer.

This results in the following procedure:

Re a): If the veneer has a moisture content of less than 8% when it arrives at the machine, the lacking moisture must be supplied to the veneer by a steam treatment unit at the infeed, or it is stored (prepared) in a conditioning room.

Re b): The necessary moisture content for forming is reached in the machine. The hot water is rolled into the veneer by means of a heated water application tank with application rolls. The moisture absorption is enhanced by a downstream heating zone. In order to reach a moisture content of 12%, it is necessary for two water application and heating zones to be installed in succession.

4. Geometry of the finished product:

The smaller the bending radius, the higher is the stress in the veneer.

In the case of readily formable veneers (e.g. beech), the smallest bending radius is about R=5 mm

In the case of poorer veneers (e.g. oak), the smallest bending radius is about R=6 mm

5. Glue application for adhesive bonding of the projecting veneer:

The gluing of the projecting veneer must be carried out using hotmelt adhesive since the veneer becomes too dry through drying of the adhesive in the air in the case of PVAC gluing and cracking occurs.

The hotmelt adhesive is applied to the back by a horizontal glue application roll. For surface gluing, all customary soft postforming hotmelt adhesive grades are used.

The hotmelt adhesive is introduced into the cavity by a spray nozzle.

Soft polyamide grades have proven useful for the cavity owing to their short solidification time when flexibility is nevertheless still present. In principle, it must be ensured that the cavity where the radius meets the particle board is as small as possible. It is essential to avoid the situation where too much adhesive is sprayed into the cavity, since this leads to “bursting open” of the veneer during forming.

6. The forming of the veneer:

The critical region during bending over and pressing down the projecting veneer is the lower radius in the region of the cavity filled with hotmelt adhesive. The lower radius region must be held continuously by means of forming shoes to prevent tearing of the veneer. The pressure zone is designed as follows.

a) Bending bar and forming roller for forming the veneer and lifting it onto the forming shoes.

b) 6 shoes at 15° in steps between 15 and 90°, for bending over and pressing down the veneer.

c) These are followed laterally by rollers which are all straight and have V2A stainless steel scrapers for pressing down the veneer laterally on the narrow side.

d) Forming shoes which enclose a radius of 90° are located throughout in the region of the cavity.

e) The upper radius is bent over by means of a bending bar, and rubber forming rollers.

f) These are followed by straight pressure rollers adjustable from above to the inlay depth.

7. Inlay technique with U-profile.

To be able to layer the veneer in the top surface with, as far as possible, an invisible joint, the veneer is scratched in the pressure zone by means of a saw and then pressed in by means of pressure rollers. The slitting saw operates synchronously.

Wood can be coated in a particularly environmentally friendly manner with UV finishes, similarly to water-based finishes. UV stands for ultraviolet and designates the method of curing the finish. The chemical reaction taking place here is initiated by high-energy UV light: so-called photoinitiators absorb light energy and decompose into reactive cleavage products which initiate a rapid chain reaction—the coating film cures completely in only a few seconds.

The UV curing method can be found in solvent-containing and in water-based coating systems. The latter are generally used as UV spray finishes because the solvent emissions in production are minimized thereby. On flat surfaces, it is even possible to apply completely solvent-free UV finishes by means of a roll. An overview of the chemistry and technology of the radiation curing is given in P. G. Garratt, “Strahlenhärtung” [Radiation curing] (editor: U. Zorll), publisher: Curt R. Vincentz, Hanover.

UV finishes are distinguished by extremely resistant films. Immediately after curing, the coat surface has already achieved its properties: the components can be packed and further processed immediately. Virtually all products comply with VdL Guideline 02 and the furniture standard according to DIN 68861 (EN 12720). They are intended to be used exclusively for mass production.

The extent to which UV curing has already become a standard production method can be illustrated by numerous examples. Thus, in addition to surfaces of living room and bedroom furniture, table tops, kitchen cabinet fronts, doors and panels, complete chairs or seat frames and other profiles and carcass parts are coated with UV-curable finishes via the roll-coating, casting and spraying method and cured, and in addition finished parquets and floorboards are coated with such highly resistant systems.

Conventional radiation-curable coating systems frequently contain solvents and/or monomers (reactive diluents). An environmentally friendly alternative comprises aqueous radiation-curable coating systems, which however are only slowly becoming established in the area of industrial application (wood finishing and furniture industry).

Various aqueous radiation-curable binder systems are currently available on the market. They can in principle be divided into two classes, on the one hand into water-soluble or water-dilutable and emulsions and, on the other hand, into colloidal dispersions. In contrast to the conventional systems, the aqueous systems cannot be cured directly after application of the coat. A requirement for the rapid start of curing is fast and complete evaporation of the water from the applied film. The evaporation requires energy, space and time. However, the curing can take place immediately after the release of water.

Nevertheless, aqueous radiation-curable coating systems have a number of ecological, physiological and, not least, application technology advantages:

little or no emissions

no skin irritation, no sensitization, no odor

less risk of fire and explosion

application with conventional coating machines

cleaning of the application machines and removal of spilled finish with water

physical drying prior to curing, i.e. correction of the films is possible

adjustment of viscosity with water and/or rheology additives

novel formulation possibilities, i.e. low film shrinkage owing to absence of monomers

formulation of coating systems having a low solids content (without concomitant use of organic solvents)

The surface treatment of the veneered wood with radiation-curable coating systems is carried out, according to the known prior art only after the direct postforming method.

In the procedure to date, the coating of the postformed veneered wood is therefore carried out in two separate stages. In the first stage, the postformed edge of the veneered wood is coated. In the second stage, the non-postformed surface of the veneered wood is coated. In the first stage, it is still possible to distinguish between roll coating and spray coating. This procedure is not very efficient with regard to the required high throughput. Moreover, the achievement of a clean and virtually invisible transition between the edge coating and the surface coating sets very high requirements with regard to the coating technology.

(Radiation-curable) coating systems which permit extensive coating of the veneered wood in the region of the subsequent surfaces and edges of the shaped article and whose application is effected prior to the direct postforming method would be desirable. With such systems, the required operations could be substantially reduced and the overall process accordingly designed to be more economical. However, owing to their material properties, the radiation-curable coating systems known to date are not suitable for the demanding processing conditions of the direct postforming method. This applies both to the conventional coating systems, such as unsaturated polyester resins, epoxyacrylates, unsaturated resins of N-heterocyclic compounds, polyester acrylates, urethane acrylates, silicone acrylates, monomer-containing saturated resins, unsaturated acrylic resins, unsaturated amines, thiolene systems and combinations thereof with monomers and to water-based radiation-curable coating systems.

Radiation-curable coating systems for veneered wood which can be applied before the direct postforming method have not been known to date.

It was therefore the object of the present invention to develop a flexible postformable coating system which does not have the stated disadvantages of the prior art but has good performance characteristics and at the same time can be produced taking into account ecological, economic and physiological aspects.

This object was achieved, according to the invention, by providing a flexible and/or postformable coating system based on polyurethane dispersions, which is obtainable by reacting

a) 25 to 250 parts by weight of a polyol component (A) comprising

a₁) 10 to 100 parts by weight of an unsaturated polymeric polyol (A) (i) having one or more double bonds capable of free radical polymerization and two or more hydroxyl groups and a molecular weight of 200 to 6000 dalton and/or 10 to 100 parts by weight of a polymeric polyol (A) (ii) having two or more hydroxyl groups and a molecular weight of 500 to 6000 dalton,

a₂) 2.5 to 25 parts by weight of a low molecular weight polyol component (A) (iii) having two or more hydroxyl groups and a molecular weight of 50 to 249 dalton,

a₃) 2.5 to 25 parts by weight of a low molecular weight and anionogenic polyol component (A) (iv) having two or more hydroxyl groups and one or more inert carboxyl and/or sulfo group(s) and a molecular weight of 100 to 1000 dalton,

b) 50 to 250 parts by weight of a polyisocyanate component (B), comprising at least one polyisocyanate, polyisocyanate derivative and/or polyisocyanate homolog having two or more aliphatic and/or aromatic isocyanate groups,

c) 2 to 50 parts by weight of a polyamine component (C), comprising

c₁) 1 to 25 parts by weight of a tertiary amine as neutralizing component (C)(i) and

c₂) 1 to 25 parts by weight of a polyamine having two or more primary and/or secondary amino groups as chain-extender component (C)(ii),

d) 0 to 100 parts by weight of a solvent component (D), comprising an inert organic solvent and/or a copolymerizable reactive diluent having one or more double bonds capable of free radical polymerization, and

e) 50 to 1500, in particular 250 to 1500, parts by weight of water to give a solvent-free or low-solvent polyurethane dispersion and then further processing this by adding

f) if required, 0.5 to 50 parts by weight of a photoinitiator component (E) and

g) 0.5 to 500 parts by weight of a formulation component (F) to give the end product (postforming coating).

It has in fact surprisingly been found that, by the use of the flexible and/or postformable coating system according to the invention and based on (radiation-curable) polyurethane dispersions, not only can the production of industrially coated veneered wood shaped articles be significantly simplified but furthermore a plaster effect can be achieved by plasticizing the veneer or the coating material in the postforming method, which plaster effect permits smaller bending radii depending on the deformability of the veneer and dispenses with the need for steam treatment or moistening of the veneer. Moreover, it was not foreseeable that the flexible and/or postformable coating system according to the invention is also suitable as an adhesive for gluing the veneer or the coating material to the blank material and/or base material.

The flexible and/or postformable coating system according to the invention is defined by its multistage production method.

For carrying out this method using the techniques customary in polyurethane chemistry, a premix of 10 to 100 parts by weight of a polymeric polyol (A)(i) having one or more double bonds capable of free radical polymerization and/or 10 to 100 parts by weight of a polymeric polyol (A) (ii), 2.5 to 25 parts by weight of a low molecular weight polyol component (A) (iii), 2.5 to 25 parts by weight of a low molecular weight and anionogenic polyol component (A) (iv) and 0 to 100 parts by weight of a solvent component (D) is prepared in reaction stage a₁) and is reacted, in reaction stage a₂), with 50 to 250 parts by weight of a polyisocyanate component (B), optionally stepwise and optionally in the presence of a catalyst to give a polyurethane prepolymer. The preparation of the polyurethane prepolymer according to reaction stage a₂) is preferably effected by a procedure in which the component (B) is added to or metered into the mixture of the components (A) (i) and/or (A) (ii), (A) (iii), (A) (iv) and (D) within a period of a few minutes to a few hours and/or, alternatively, the mixture of components (A) (i) and/or (A)(ii), (A)(iii), (A)(iv) and (D) is added to or metered into component (B), optionally stepwise, within a period of a few minutes to a few hours.

In reaction stage a₁), it is alternatively also possible to react 10 to 100 parts by weight of a polymeric polyol (A) (i) having one or more double bonds capable of free radical polymerization and/or 10 to 100 parts by weight of a polymeric polyol (A) (ii), 2.5 to 25 parts by weight of a low molecular weight polyol component (A) (iii) and 0 to 100 parts by weight of a solvent component (D) with 50 to 250 parts by weight of a polyisocyanate component (B), optionally in the presence of a catalyst, to give a polyurethane preadduct. The preparation of the polyurethane preadduct according to reaction stage a₁) is preferably carried out by a procedure in which the component (B) is added to or metered into the mixture of (A) (i) and/or (A) (ii), (A) (iii) and (D) within a period of a few minutes to a few hours or, alternatively, the mixture of the components (A)(i) and/or (A)(ii), (A) (iii) and (D) is added to or metered into component (B) within a period of a few minutes to a few hours. In the subsequent reaction stage a₂), the completely or partly reacted polyurethane preadduct from stage a₁) is reacted with 2.5 to 25 parts by weight of low molecular weight and anionogenic polyol component (A)(iv) to give the corresponding polyurethane prepolymer. The preparation of the polyurethane prepolymer according to reaction stage a₂) is preferably carried out by a procedure in which the finely milled polyol component (A)(iv) having a mean particle size of <150 μm is added to or metered into the polyurethane preadduct from stage a₁) within a period of a few minutes to a few hours. When the process is carried out appropriately, or the reaction is incomplete, the polyurethane preadduct used in reaction stage a₂) and obtained from reaction stage a₁) may also have free hydroxyl groups in addition to isocyanate groups and/or polyisocyanate monomers.

The procedure for reaction stages a₁) and a₂) is relatively uncritical with regard to the reaction conditions. In reaction stages a₁) and a₂), the reaction batch is stirred at 60 to 120° C., preferably at 80 to 100° C., under an inert gas atmosphere with utilization of the exothermic nature of the polyaddition reaction until the calculated or theoretical NCO content is reached. The required reaction times are usually in the region of a few hours and are decisively influenced by reaction parameters such as the reactivity of the components, the stoichiometry of the components and the temperature.

The reaction of the components (A), (B) and (D) in reaction stages a₁) and/or a₂) can be carried out in the presence of a catalyst customary for polyaddition reactions with polyisocyanates. If required, these catalysts are added in amounts of 0.01 to 1% by weight, based on the components (A) and (B). Customary catalysts for polyaddition reactions with polyisocyanates are, for example, dibutyltin oxide, dibutyltin dilaurate (DBTL), triethylamine, tin(II) octanoate, 1,4-diazabicyclo[2.2.2]octane (DABCO), 1,4-diazabicyclo[3.2.0]-5-nonene (DBN) and 1,5-diazabicyclo[5.4.0]-7-undecene (DBU).

The component (A)(i) consists of at least one unsaturated polymeric polyol having one or more double bonds capable of free radical polymerization and two or more hydroxyl groups reactive toward polyisocyanates and an average molecular weight (number average) of 200 to 6000 dalton, preferably 250 to 6000 dalton. Unsaturated polyesterpolyols and other compounds may be used as suitable polymeric polyols (A)(i). Suitable unsaturated polyesterpolyols are, for example, condensates based on aliphatic and/or aromatic alcohols, in particular polyols such as ethylene glycol and/or 1,2(1,3)-propylene glycol and/or 1,4-butylene glycol and/or diethylene glycol and/or dipropylene glycol and/or neopentylglycol and/or glycerol and/or trimethylolpropane, epoxides, saturated aliphatic or aromatic carboxylic acids and derivatives thereof (anhydrides, esters), such as glutaric acid and/or adipic acid and/or phthalic acid and/or isophthalic acid and/or terephthalic acid, unsaturated aliphatic or aromatic carboxylic acids, such as maleic acid (anhydride), fumaric acid, itaconic acid, acrylic acid or methacrylic acid. Linear or difunctional aliphatic and/or aromatic polyesterpolyols containing 100 to 1000 meq·(100 g)⁻¹ of double bonds capable of free radical polymerization and having an average molecular weight (number average) of 200 to 3000 dalton are preferably used.

Other suitable compounds are, for example, reaction products of epoxides and (meth)acrylic acid, such as bisphenol A glycerolate diacrylate, and reaction products of hydroxyalkyl (meth)acrylates, polyisocyanates and compounds having three groups reactive toward polyisocyanates. Compounds containing 100 to 1000 meq·(100 g)⁻¹ of double bonds capable of free radical polymerization and having an average molecular weight (number average) of 500 to 3000 dalton are preferably used. In principle, it is also possible to use polyalkylene glycols, polycaprolactones, polycarbonates, α, ω-polymethacrylatediols, α, ω-dihydroxyalkylpolydimethyl-siloxanes, macromonomers or telechels modified with groups capable of free radical polymerization, or mixtures thereof.

The component (A)(ii) consists of at least one polymeric polyol having two or more hydroxyl groups reactive toward polyisocyanates and an average molecular weight (number average) of 500 to 6000 dalton. Polymeric polyols, such as polyalkylene glycols, aliphatic and/or aromatic polyesters, polycaprolactones, polycarbonates, alkyd resins, reaction products of polyfunctional epoxy resins and unsaturated fatty acids, α, ω-polymethacrylatediols, α, ω-dihydroxyalkylpolydimethylsiloxanes, macromonomers, telechels or mixtures thereof may be used as suitable polymeric polyols (A) (ii). Suitable polyalkylene glycols are, for example, polypropylene glycols, polytetramethylene glycols or polytetrahydrofurans, reaction products of monofunctional polyalkylene glycols, polyisocyanates and compounds having three groups reactive toward polyisocyanates and hydrophobically modified block copolymers, hydrophobic block copolymers and hydrophobically modified random copolymers based on polyalkylene glycols. Linear or difunctional polypropylene glycols, respectively, having an average molecular weight (number average) of 1000 to 3000 dalton are preferably used.

Suitable aliphatic and/or aromatic polyesters are, for example, condensates based on aliphatic and/or aromatic alcohols, in particular polyols, such as ethylene glycol and/or 1,2(1,3)-propylene glycol and/or 1,4-butylene glycol and/or diethylene glycol and/or dipropylene glycol and/or 1,6-hexamethylene glycol and/or neopentylglycol and/or glycerol and/or trimethylolpropane, and aliphatic and/or aromatic carboxylic acids and derivatives thereof (anhydrides, esters), such as glutaric acid and/or adipic acid and/or phthalic acid and/or isophthalic acid and/or terephthalic acid and/or 5-sulfoisophthalic acid (dimethyl ester) sodium. Linear or difunctional, respectively, aliphatic and/or aromatic polyesterpolyols having an average molecular weight (number average) of 1000 to 3000 dalton are preferably used.

Polycaprolactones based on ε-caprolactone, polycarbonates based on dialkyl carbonates and glycols and combinations thereof likewise belong to the group consisting of the polyesters. Linear or difunctional types having an average molecular weight (number average) of 1000 to 3000 dalton are preferably used.

Linear or difunctional types having an average molecular weight (number average) of 500 to 3000 dalton are preferably used as α, ω-polymethacrylatediols (e.g. TEGO® Diol BD 1000, TEGO® Diol MD 1000 N, TEGO® Diol MD 1000 X, from Tego Chemie Service GmbH) and α, ω-dihydroxyalkylpolydimethylsiloxanes.

The component (A) (iii) consists of at least one low molecular weight polyol having two or more hydroxyl groups reactive toward polyisocyanates and an average molecular weight of 50 to 249 dalton. For example, ethylene glycol, 1,2(1,3)-propylene glycol, 1,4-butylene glycol, 1,6-hexamethylene glycol, 2-methyl-1,3-propanediol, neopentylglycol, cyclohexanedimethanol, glycerol, trimethylolethane, trimethylolpropane, pentaerythritol or mixtures thereof may be used as suitable low molecular weight polyols.

The component (A)(iv) consists of at least one low molecular weight and anionogenic polyol having a molecular weight of 100 to 1000 dalton and two or more hydroxyl groups reactive toward polyisocyanates and one or more carboxyl and/or sulfo groups which are inert to polyisocyanates and some or all of which can be converted into carboxylate and/or sulfonate groups in the presence of bases. The component (A) (iv) can also be used in the form of its salts with bases. For example, 2-hydroxymethyl-3-hydroxypropanoic acid or dimethylolacetic acid, 2-hydroxymethyl-2-methyl-3-hydroxypropanoic acid or dimethylolpropionic acid, 2-hydroxymethyl-2-ethyl-3-hydroxypropanoic acid or dimethylolbutyric acid, 2-hydroxymethyl-2-propyl-3-hydroxypropanoic acid or dimethylolvaleric acid, citric acid, tartaric acid, tris(hydroxymethyl)methyl-3-aminopropanesulfonic acid (TAPS, from Raschig GmbH), building blocks based on 1,3-propanesultone (from Raschig GmbH) and/or 3-mercaptopropanesulfonic acid sodium salt (MPS, from Raschig GmbH) can be used as low molecular weight and anionically modifiable polyols. These building blocks can, if required, also have amino groups instead of hydroxyl groups. Bishydroxyalkane-carboxylic acids having a molecular weight of 100 to 200 dalton are preferably used, in particular 2-hydroxymethyl-2-methyl-3-hydroxypropanoic acid or dimethylolpropionic acid (trade name DAMPA® from Trimet Technical Products, Inc.).

The polyisocyanate component (B) consists of at least one polyisocyanate, polyisocyanate derivative or polyisocyanate homolog having two or more aliphatic and/or aromatic isocyanate groups. In particular, the polyisocyanates sufficiently well known in polyurethane chemistry, or combinations thereof, are suitable. For example, 1,6-diisocyanatohexane (HDI), 1-isocyanato-5-isocyanatomethyl-3,3,5-trimethylcyclohexane or isophorone diisocyanate (IPDI), bis(4-isocyanato-cyclohexyl)methane (H₁₂MDI), 1,3-bis(l-isocyanato-1-methylethyl)benzene (m-TMXDI) or technical-grade isomer mixtures of the individual aliphatic polyisocyanates may be used as suitable aliphatic polyisocyanates. For example, 2,4-diisocyanatotoluene or toluene diisocyanate (TDI), bis(4-isocyanatophenyl)methane (MDI) and optionally its higher homologs (polymeric MDI) or technical-grade isomer mixtures of the individual aromatic polyisocyanates may be used as suitable aromatic polyisocyanates. Furthermore, the so-called “coating polyisocyanates” based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI) are in principle also suitable. The term “coating polyisocyanates” denotes those derivatives of these diisocyanates which have allophanate, biuret, carbodiimide, isocyanurate, uretdione or urethane groups and in which the residual content of monomeric diisocyanates was reduced to a minimum according to the prior art. In addition, modified polyisocyanates which are obtainable, for example, by hydrophilic modification of “coating polyisocyanates” based on 1,6-diisocyanatohexane (HDI) can also be used. The aliphatic polyisocyanates are preferable to the aromatic polyisocyanates. Furthermore, polyisocyanates having isocyanate groups of different reactivity are preferred. Polyisocyanates having isocyanate groups of different reactivity are preferably used to obtain narrower molecular weight distributions with lower nonuniformity. Accordingly, polyurethane prepolymers having a linear structure which are composed of difunctional polyol and polyisocyanate components are preferred.

The ratio of the number of equivalents of NCO to that of OH of the components (A) and (B) is preferably adjusted to a value of 1.25 to 2.5, particularly preferably 1.4 to 2.0.

The solvent component (D) consists of at least one inert organic solvent and/or at least one reactive diluent having one or more double bonds capable of free radical polymerization. For example, low-boiling solvents, such as acetone and methyl ethyl ketone, and/or high-boiling solvents, such as N-methylpyrrolidone and dipropylene glycol dimethyl ether (Proglyde DMM®), can be used as suitable organic solvents. After the production, the low-boiling organic solvents can be removed again, if required by redistillation. According to a particularly preferred embodiment, the polyurethane dispersion contains less than 10% by weight of organic solvents.

Useful reaction diluents include for example, monofunctional monomers, such as butyl (meth)acrylate, isobutyl (meth)acrylate, tert-butyl (meth)acrylate, hexyl (meth)acrylate, cyclohexyl (meth)acrylate, octyl (meth)acrylate, 2-ethylhexyl (meth)acrylate, 3,3,5-trimethylhexyl (meth)acrylate, decyl (meth)acrylate, dodecyl (meth)acrylate, isododecyl (meth)acrylate, octadecyl (meth)acrylate, 2-hydroxyethyl (meth)acrylate, hydroxypropyl (meth)acrylate (isomer mixture), benzyl (meth)acrylate, phenoxyethyl (meth)acrylate, isobornyl (meth)acrylate, tetrahydrofurfuryl (meth)acrylate, dicyclopentyl (meth)acrylate, (meth)acrylates which have a double bond capable of free radical polymerization and are based on methoxypolyethylene glycol, bifunctional monomers, such as 1,6-hexanediol diacrylate, dipropylene glycol diacrylate, tripropylene glycol diacrylate, triethylene glycol diacrylate, tetraethylene glycol diacrylate, polyethylene glycol (200 and 400) diacrylate, ethoxylated and propoxylated neopentylglycol diacrylate, polyfunctional monomers, such as trimethylolpropane triacrylate, ethoxylated and propoxylated trimethylolpropane triacrylate, ditrimethylolpropane tetraacrylate, propoxylated glyceryl triacrylate, tris(2-hydroxyethyl)isocyanurate triacrylate, alkoxylated tetraacrylates and highly alkoxylated tetraacrylates and further (meth)acrylates which have two or more double bonds capable of free radical polymerization and are based on low molecular weight and/or high molecular weight polyols or mixtures thereof.

The viscosity of the polyurethane prepolymers is relatively low and substantially independent of the structure of the polyol and polyisocyanate components used. An addition of solvents for reducing the viscosity or for improving the dispersing properties of the polyurethane prepolymers is therefore necessary in general only in a small amount—if at all.

The working-up of the polyurethane prepolymer with 2 to 50 parts by weight, preferably 5 to 50 parts by weight, of the polyamine component (C) is effected in reaction stages a₃) and a₄).

The polyurethane prepolymer from reaction stage a₂) is reacted in reaction stage a₃), before and/or during the dispersing in 50 to 1500 parts by weight of water, preferably 250 to 1500 parts by weight of water, with 1 to 25 parts by weight, preferably 2.5 to 25 parts by weight, of a neutralizing component (C)(i) for neutralizing some or all of the carboxyl and/or sulfo groups (direct or indirect neutralization). In the case of a direct neutralization, the neutralizing component (C) (i) is introduced into the polyurethane prepolymer before the dispersing in water; in the case of an indirect neutralization, the neutralizing component (C)(i) is initially introduced before the dispersing in water. If required, a combination of direct and indirect neutralization can also be used.

During the dispersing, the polyurethane prepolymer is transferred to the dispersing medium and thereby forms a polyurethane prepolymer dispersion. The neutralized polyurethane prepolymer forms micelles which have stabilizing carboxylate and/or sulfonate groups on the surface and reactive isocyanate groups in the interior. All cationic counterions for the anionic carboxylate and/or sulfonate groups are dissolved in the dispersing medium. The terms “dispersing” and “dispersion” include the meaning that, in addition to dispersed components having a micellar structure, solvated and/or suspended components may also be contained. For transfer of the polyurethane prepolymer into the aqueous phase, either the polyurethane prepolymer can be stirred into the dispersing medium or the dispersing medium can be stirred into the polyurethane prepolymer (inverse method).

The hardness of the water used is unimportant for the method, and it is therefore not necessary to use distilled or demineralized water. High hardnesses result in further reduction in the water absorption of the polyurethane dispersion without adversely affecting their material properties.

The reaction stage a₃) is preferably carried out at a temperature of 40 to 60° C., in particular at about 50° C.

The neutralizing component (C) (i) consists of one or more bases which serve for neutralizing some or all of the carboxyl and/or sulfo groups. If the component (B)(i) is already present in the form of its salts, the neutralizing component (D) can be dispensed with. For example, tertiary amines, such as N,N-dimethylethanolamine, N-methyldiethanolamine, triethanolamine, N,N-dimethylisopropanolamine, N-methyldiisopropanolamine, triisopropylamine, N-methylmorpholine, N-ethylmorpholine, triethylamine or ammonia, or alkali metal hydroxides, such as lithium hydroxide, sodium hydroxide or potassium hydroxide, or mixtures thereof may be used as suitable bases. Tertiary amines and in particular triethylamine are preferably used.

The neutralizing component (C)(i) is added in an amount such that the degree of neutralization, based on the free carboxyl and/or sulfo groups of the polyurethane prepolymer, is preferably 50 to 100 equivalent %, particularly preferably 80 to 90 equivalent %. In the neutralization, the carboxyl and/or sulfo groups are converted into carboxylate and/or sulfonate groups, which serve for anionic modification or stabilization of the polyurethane dispersion.

The neutralized and dispersed polyurethane prepolymer (polyurethane prepolymer dispersion) from reaction stage a₃) is reacted, in the subsequent reaction stage a₄), with 1 to 25 parts by weight, preferably 2.5 to 25 parts by weight, of a chain-extender component (C) (ii).

The chain-extender component (C)(ii) consists of at least one polyamine having two or more primary and/or secondary amino groups reactive toward polyisocyanates. For example, adipic acid dihydrazide, ethylenediamine, diethylenetriamine, triethylenetetramine, tetra-ethylenepentamine, pentaethylenehexamine, dipropylene-triamine, hexamethylenediamine, hydrazine, isophorone-diamine, N-(2-aminoethyl)-2-aminoethanol, adducts of salts of 2-acrylamido-2-methylpropane-1-sulfonic acid (AMPS®) and ethylenediamine, adducts of salts of (meth)acrylic acid and ethylenediamine, adducts of 1,3-propane sulfone and ethylenediamine or any desired combination of these polyamines may be used as suitable polyamines. Difunctional primary amines and in particular ethylenediamine are preferably used.

The chain-extender component (C) (ii) is added in an amount such that the degree of chain extension, based on the free isocyanate groups of the polyurethane prepolymer, is 50 to 100 equivalent %, preferably 70 to 80 equivalent %. The chain-extender component (C) (ii) can be diluted in the weight ratio of 1:1 to 1:10 in previously removed portions of water in order to suppress the additional exothermicity by hydration of the amines.

The chain extension of the polyurethane prepolymer dispersion leads to an increase in the molecular weight within the micelles and to the formation of a polyurethane-polyurea dispersion of high molecular weight. The chain-extender component (C)(ii) reacts with reactive isocyanate groups substantially more rapidly than water. After reaction stage a₄), any free isocyanate groups still present are subjected to complete chain extension with water.

The content of double bonds capable of free radical polymerization in the polyurethane prepolymer of the components (A) to (C) or (A) to (D) in the presence of a reactive diluent is preferably adjusted to 0 to 100 meq·(100 g)⁻¹, particularly preferably to 30 to 50 meq·(100 g)⁻¹.

The content of carboxylate and/or sulfonate groups in the polyurethane polymer of the components (A) to (C) or (A) to (D) in the presence of a reactive diluent is preferably adjusted to 10 to 50 meq·(100 g)⁻¹, particularly preferably to 15 to 45 meq·(100 g)⁻¹, and the acid number is preferably adjusted to 5 to 25 meq KOH·g⁻¹, particularly preferably to 7.5 to 22.5 meq KOH·g⁻¹.

The mean particle sizes of the polyurethane dispersion of the components (A) to (D) are preferably 50 to 500 nm, particularly preferably 100 to 400 nm.

The average molecular weights (number average) of the polyurethane dispersion of the components (A) to (D) are preferably 50000 to 500000 dalton.

The low-solvent or solvent-free polyurethane dispersion from reaction stage a₄) is formulated in stage a₅) with, if required, 0.5 to 50 parts by weight of a photoinitiator component (E) and 0.5 to 500 parts by weight of a formulation component (F) in any desired sequence. For this purpose, the constituents of the components (E) and (F) are introduced simultaneously or sequentially into the polyurethane dispersion. Alternatively, the constituents of the components (E) and/or (F) can be completely or partly added to the reaction stages a₃) and/or a₄). The photoinitiator component (F) necessary for the UV-induced free radical polymerization is required only when the component (A)(i) is contained in the polyurethane dispersion comprising the components (A) to (D) and/or the component (D) contains a reactive diluent.

Suitable photoinitiators which may be used are compounds in which the free radical formation is caused by homolytic cleavage (intramolecular cleavage) or by intermolecular hydrogen abstraction. Suitable photoinitiators are, for example, α-cleavers, such as benzoin ethers, benzil ketals, α, α-dialkoxyacetophenones, α-hydroxyalkylphenones or α-hydroxyalkyl aryl ketones, α-aminoalkylphenones, acylphosphine oxides, phosphine oxide ketals and hydrogen abstractors (H abstractors), such as benzil, benzophenone and substituted benzophenones, thioxanthones or mixtures thereof.

α-Cleavers, such as benzoin isopropyl ether, benzoin butyl ether, benzil dimethyl ketal, α, α-diethoxyacetophenone, α-hydroxy-α-methylpropiophenone (HMEPK), α-hydroxy-4-(2-hydroxyethoxy)-α-methylpropiophenone (HMEPK-EO), 2-hydroxy-2-methyl-1-phenylpropan-1-one, (1-hydroxycyclohexyl) phenylketone (HCPK), poly[2-hydroxy-2-methyl-1-[4-(l-methylvinyl)phenyl]propan-1-one], 2-methyl-1-[4(methylthio)phenyl]-2-morpholinopropan-2-one (MMMP), 2-benzyl-2-dimethylamino-l-(4-morpholinophenyl)butan-1-one (BDMP), diphenyl-(2,4,6-trimethylbenzoyl)phosphine oxide (MAPO), phenylpropoxy-(2,4,6-trimethylbenzoyl)phosphine oxide (MAPO-L), phenylbis-(2,4,6-trimethylbenzyl)phosphine oxide (BAPO), bis(2,6-dimethoxybenzoyl)-2,4,4-trimethyl-pentylphosphine oxide in combination with α-hydroxyacetophenone, and hydrogen abstractors (H abstractors), such as benzil, benzophenone (BP), 3-benzophenonyl acrylate (BPA), 2,4,6-trimethylbenzophenone, 4-methylbenzophenone, 3,3-dimethyl-4-methoxybenzophenone, 4-phenylbenzophenone, 4,4′-bis(dimethylamino)benzophenone (Michler's ketone), mixtures of 2- and 4-chlorothioxanthones, mixtures of 2- and 4-isopropylthioxanthones or 2,4-dimethyl-thioxanthone, or mixtures thereof are preferably used.

Photoinitiators constitute the basic requirement for the curing of UV-curable finishes. Since the energy density of the UV beams are not sufficient for supplying the activation energy required for polymerization, it is necessary to take the indirect route by using photoinitiators or photosensitizers. The choice of the photoinitiators is very critical. They are one of the factors responsible for the reactivity of the system and for substantial properties of the cured film. The effects and interactions which emanate from photoinitiators or photosensitizers are complex and have often been described in the technical literature.

The photoinitiation of free radical polymerization processes can be divided into three stages:

a) Formation of the chemically excited state of the initiator molecules by direct light absorption or by energy transfer from a photochemically excited photosensitizer.

b) Formation of the initiator radicals from the excited state, either by photodefragmentation or by hydrogen abstraction from a hydrogen donor.

c) Chain initiation by reaction of the initiator radical with the reactive binder system, consisting of monomers, oligomers, prepolymers, polymers.

In principle, the absorption bands of the initiator should correspond as far as possible to the main emission bands of the UV lamps. The magnitude of the extinction coefficient of the photoinitiator at these wavelengths is decisive. Extinction coefficients which are too high result in the light being absorbed practically already at the surface. Although this results in more advantageous superficial drying of the finish, it also causes poor complete curing, which manifests itself, for example, in pronounced wrinkling.

In the case of pigmented systems in turn, the extinction coefficient of the photoinitiator should be as high as possible so that it can also absorb in the presence of the pigments.

For example, high-pressure mercury lamps or medium-pressure mercury lamps, ozone-free lamps, doped mercury lamps, microwave-excited UV lamps (H lamps, D lamps, V lamps), superactinic fluorescent lamps (TL-03 and TL-05 fluorescent lamps) and UV flash lamps which have a lamp power of up to 275 W·cm⁻¹, preferably 80 to 120 W·cm⁻¹, can be used as suitable UV radiation sources.

Antifoams, deaerators, lubricating and leveling additives, radiation-curing additives, dispersants, substrate wetting additives, water repellents, rheology additives, such as polyurethane thickeners, coalescence auxiliaries, dulling agents and, if required, fillers, pigments and further additives in suitable combination or mixtures thereof can be used as suitable formulation component (F).

The solids content of the postformable coating system comprising the components (A) to (F) is preferably adjusted to 10 to 70% by weight, particularly preferably to 20 to 70% by weight and most preferably to 30 to 60% by weight.

The solvent content of the postformable coating system comprising the components (A) to (F) is preferably adjusted to 0 to 10% by weight, particularly preferably to 0 to 5% by weight.

It is readily possible in the present invention to combine the solvent-free or low-solvent polyurethane dispersion from stage a₅) with further aqueous polymer dispersions or other polymers in the subsequent stage a₆).

The coating system according to the invention is outstandingly suitable for the system structure comprising primer and/or top coat(s) for veneered wood and further coating materials, one or more polyurethane dispersion(s) based on components (A) to (D) and, if required, further polymers and/or reactive resins preferably being used as binders.

According to the present invention, in particular papers and/or cardboard boxes and/or plastics films and/or metal foils are to be regarded as further coating materials.

The polyurethane dispersions used as binders and based on the components (A) to (D) are preferably capable of film formation on physical drying.

The application to veneered wood and further coating materials as primer and/or top coat is effected in one or more coats in a total amount of, preferably, 1 to 1000 g·m⁻² of the area to be coated and per operation, with a total dry coat thickness of, preferably, 5 to 500 μm, by the methods known from coating technology, such as, for example, flooding, casting, knife coating, spraying, brushing, immersion or roll-coating.

According to a preferred embodiment, the application of the coating system according to the invention is effected in the following steps:

In stage b₁) the veneers and further coating materials are adhesively bonded to an optionally profiled blank and/or base material using suitable glues.

In stage b₂) the prefabricated workpiece from stage b₁) is subjected to grinding and dedusting and is pretreated, optionally by application of deresinifying agents and/or brighteners and/or colorants and pickling agents and/or pore fillers and forced drying. The application of the pretreatment compositions can be effected automatically or manually and may imply finishing work.

Thereafter, the polyurethane dispersion from stage a₄), a₅) or a₆) is applied in stage b₃), optionally in combination with further polymers and/or reactive resins, in one or more coats as a primer and/or top coat, optionally in pigmented form, to the optionally pretreated workpiece from stage b₁) by casting, spraying or roll-coating, subjected to forced drying, cured optionally by means of UV-induced free radical polymerization and optionally subjected to grinding and dedusting (intermediate grinding), it being possible for these process steps to be repeated if required and to be carried out in any desired sequence.

The forced drying can be carried out at temperatures of, for example, 30 to 150° C.

The coating system from stage b₃) which is applied to veneered wood or further coating materials and cured is then subjected in stage b₄) to a direct postforming method or a standard postforming method. The parameters of the postforming method or of the postforming machine are dependent on the type of workpiece and the geometry of the shaped article to be produced and therefore cannot be generalized.

Depending on the deformability of veneers or coating materials to be processed, bending radii of 1 to 100 mm, preferably 5 to 6 mm, can be produced in the postforming method.

The use of the flexible and/or postformable coating system according to the invention in the postforming method (PM) results in the following performance and processing engineering advantages:

Plastification of the processed veneers or coating materials

Plaster effect on the processed workpiece

Use during the PM

Smooth and crack-free surface on the processed workpiece after the PM

It is possible to dispense with a steam treatment or moistening of the veneer or coating material

After the postforming method is complete, postcuring of the flexible and/or postformable coating system can, if required, also be effected by self-crosslinking during oxidative drying or another type of chemical crosslinking.

The shaped article produced in stage b₄) is cooled and stacked in stage b₅). The required block strength is reached immediately.

The flexible and/or postformable coating system can also be subjected to radiation curing by means of UV-induced free radical polymerization only after the direct postforming method according to stage b₄), as an alternative to stage b₃).

Moreover, as an alternative to stage b₃), the application of the polyurethane dispersion (postforming coating) from stage a₄), a₅) or a₆) can be effected in two-component form in combination with suitable curing agents.

After forced drying and, if required, after radiation curing by means of UV-induced free radical polymerization, the flexible and/or postformable coating system has a tensile strength of, preferably, 10 to 75 MPa, an elongation at the tensile strength or an elongation at break of, preferably, 50 to 500% and a Konig pendulum hardness of, preferably, 50 to 150 s at a coat thickness of 5 to 500 μm.

The coating system according to the invention and based on polyurethane dispersions can be used as a primer and top coat for all types of veneered woods in the form of furniture, windows, strips, doors, casings, parquet floors, veneer floors and further finished products, postforming elements and shaped articles of any desired geometry.

In the present invention, the polyurethane dispersion (postforming coating) from stage a₄), a₅) or a₆) can be readily used as a primer coat and a one-coat or multicoat acrylic finish as a top coat.

Solid timbers based on beech, yew, spruce, pine, larch, fir, Weymouth pine, Swiss stone-pine, maple, birch, pear, oak, alder, ash, cherry, lime, walnut, poplar, plane, elm, Brazilian pine, abachi, afrormosia, afzelia, ebony/macassar ebony, limba, mahogany, makore, mansonia, okoume/Gaboon, padouk, East Indian palisander, Rio palisander, ramin, rosewood, sapelli/sapelli mahogany, sen, sipo, teak, wenge, whitewood or zingana/zebrano can be used as suitable veneers.

It is made possible for the processor to use prefabricated veneers, veneered wood boards or further coating materials, which have been surface-treated with the flexible and/or postformable coating system according to the invention, in the direct postforming method, the standard postforming method or further applications without having to reserve corresponding coating lines for this purpose. The associated potential saving is considerable.

The present invention furthermore relates to the use of the flexible and/or postformable coating system according to the invention and based on polyurethane dispersions from stage a₄), a₅) or a₆) as an adhesive for the adhesive bonding of veneers or any desired further coating materials to any desired blank or base materials, such as, for example, wood, woodbase materials of all kinds, plastics of all kinds, metals of all kinds, MDF, HDF and composite materials of all kinds. Moreover, the polyurethane dispersion from stage a₄), a₅) or a₆) can also be used for lamination, encasing, membrane pressing technique, softforming on edge gluing machines, forming of other materials, such as, for example, coated OSB boards.

The following examples are intended to illustrate the invention in more detail.

### EXAMPLES A

### Polyurethane Dispersions

### Example A.1

### Binder for Base and/or Top Coat

The first half of a previously prepared polyol mixture comprising 36.47 g of a polyester having a hydroxyl number of about 80 mg KOH·g⁻¹ and containing 389 meq·(100 g)⁻¹ of double bonds capable of free radical polymerization (Laromer® LR 8800, from BASF AG), 145.90 g of a further polyester having a hydroxyl number of about 56.1 mg KOH·g⁻¹ (Bester® 42 H, from Poliolchimica, S.p.A.), 14.59 g of 1,4-butanediol, 21.88 g of dimethylolpropionic acid (DMPA, from Trimet Technical Products, Inc.), 0.58 g of 2,6-di-tert-butyl-p-cresol and 72.95 g of N-methylpyrrolidone is stirred with 136.14 g of isophorone diisocyanate (Vestanat IPDI, from Creanova Spezialchemie GmbH) while blanketing with nitrogen for about 1 h at 80-90° C. in a four-necked flask equipped with a KPG stirrer, a reflux condenser, a thermometer and a nitrogen blanketing means. After the addition of the second half of the previously prepared polyol mixture, stirring is continued at 80-90° C. while blanketing with nitrogen until the calculated NCO content is reached (theory: 3.70% by weight). The course of the reaction is monitored acidimetrically.

The prepolymer is then dispersed with thorough stirring in a mixture of 547.05 g of tap water and 16.51 g of triethylamine and then subjected to chain extension with 11.32 g of ethylenediamine to produce the polyurethane dispersion.

A stable polyurethane dispersion having the following characteristics is obtained:

| Characteristic | Semitranslucent |
|---|---|
| Solids content | 38% by weight |
| Charge density | 42.94 meq · (100 g)⁻¹ |

### EXAMPLE A.2

### Binder for Base and/or Top Coat

The preparation was carried out analogously to example A.1.

36.46 g of a polyester having a hydroxyl number of about 80 mg KOH·g⁻¹ and containing 389 meq·(100 g)⁻¹ of double bonds capable of free radical polymerization (Laromer® PE 44 F, from BASF AG), 145.84 g of a further polyester having a hydroxyl number of about 56.1 mg KOH·g⁻¹ (Bester® 42 H, from Poliolchimica S.p.A.), 14.58 g of 1,4-butanediol, 21.88 g of dimethylolpropionic acid, 0.73 g of 2,6-di-tert-butyl-p-cresol, 72.92 g of N-methylpyrrolidone, 136.08 g of isophorone diisocyanate, 547.08 g of tap water, 16.50 g of triethylamine and 7.92 g of ethylenediamine are used.

NCO content of the polyurethane prepolymer (theory): 3.69% by weight

A stable polyurethane dispersion having the following characteristics is obtained:

| Characteristic | Semitranslucent |
|---|---|
| Solids content | 38% by weight |
| Charge density | 42.92 meq · (100 g)⁻¹ |

### EXAMPLE A.3

### Binder for Base and/or Top Coat

The preparation was carried out analogously to example A.1.

48.48 g of a polyester having a hydroxyl number of about 80 mg KOH·g⁻¹ and containing 389 meq·(100 g)⁻¹ of double bonds capable of free radical polymerization (Laromere® LR 8800, from BASF AG), 138.50 g of a further polyester having a hydroxyl number of about 56.1 mg KOH·g⁻¹ (Bester® 42 H, from Poliolchimica S.p.A.), 13.85 g of 1,4-butanediol, 20.78 g of dimethylolpropionic acid, 0.69 g of 2,6-di-tert-butyl-p-cresol, 69.25 g of N-methylpyrrolidone, 134.02 g of isophorone diisocyanate, 550.75 g of tap water, 15.67 g of triethylamine and 8.01 g of ethylenediamine are used.

NCO content of the polyurethane prepolymer (theory) 3.70% by weight

A stable polyurethane dispersion having the following characteristics is obtained:

| Characteristic | Semitranslucent |
|---|---|
| Solids content | 38% by weight |
| Charge density | 40.76 meq · (100 g)⁻¹ |

### EXAMPLE A.4

### Binder for Base and/or Top Coat

The preparation was carried out analogously to example A.1.

35.23 g of a polyester having a hydroxyl number of about 80 mg KOH·g⁻¹ and containing 389 meq·(100 g)⁻¹ of double bonds capable of free radical polymerization (Laromer® LR 8800, from BASF AG), 140.91 g of a further polyester having a hydroxyl number of about 56.1 mg KOH·g⁻¹ (Bester® 42 H, from Poliolchimica S.p.A.), 14.09 g of 1,4-butanediol, 2.82 g of trimethylolpropane, 21.14 g of dimethylolpropionic acid, 0.42 g of 2,6-di-tert-butyl-p-cresol, 70.45 g of N-methylpyrrolidone, 141.27 g of isophorone diisocyanate, 549.55 g of tap water, 15.95 g of triethylamine and 8.18 g of ethylenediamine are used.

NCO content of the polyurethane prepolymer (theory): 3.83% by weight

A stable polyurethane dispersion having the following characteristics is obtained:

| Characteristic | Semitranslucent |
|---|---|
| Solids content | 38% by weight |
| Charge density | 41.47 meq · (100 g)⁻¹ |

### Example A.5

### Binder for Base Coat

The preparation was carried out analogously to example A.1.

133.40 g of a polyester having a hydroxyl number of about 56.1 mg KOH·g⁻¹ (Bester® 42 H, from Poliolchimica S.p.A.), 14.82 g of a polypropylene glycol having a hydroxyl number of about 56.1 mg KOH·g⁻¹ (Dow Voranol P 2000 from Dow Chemical), 23.72 g of 1,4-butanediol, 1.48 g of trimethylolpropane, 22.23 g of dimethylolpropionic acid, 74.11 g of N-methylpyrrolidone, 161.37 g of isophorone diisocyanate, 545.89 g of tap water, 16.77 g of triethylamine and 6.20 g of ethylenediamine are used.

NCO content of the polyurethane prepolymer (theory): 4.02% by weight

A stable polyurethane dispersion having the following characteristics is obtained:

| Characteristic | Semitranslucent |
|---|---|
| Solids content | 38% by weight |
| Charge density | 43.62 meq · (100 g)⁻¹ |

### EXAMPLE A.6

### Binder for Base Coat

The preparation was carried out analogously to example A.1.

35.47 g of bisphenol A glycerolate diacrylate, 141.88 g of a polyester having a hydroxyl number of about 56.1 mg KOH·g¹ (Bester® 42 H, from Poliolchimica S.p.A.), 14.19 g of 1,4-butanediol, 21.28 g of dimethylolpropionic acid, 0.57 g of 2,6-di-tert-butyl-p-cresol, 70.94 g of N-methylpyrrolidone, 142.88 g of isophorone diisocyanate, 549.06 g of tap water, 16.06 g of triethylamine and 7.68 g of ethylenediamine are used.

NCO content of the polyurethane prepolymer (theory): 3.59% by weight

A stable polyurethane dispersion having the following characteristics is obtained:

| Characteristic | Semitranslucent |
|---|---|
| Solids content | 38% by weight |
| Charge density | 41.75 meq · (100 g)⁻¹ |

### EXAMPLE A.7

### Binder for Base Coat

The preparation was carried out analogously to example A.1.

56.72 g of bisphenol A glycerolate diacrylate, 126.05 g of a polyester having a hydroxyl number of about 56.1 mg KOH·g¹ (Bester® 42 H, from Poliolchimica S.p.A.), 12.60 g of 1,4-butanediol, 18.91 g of dimethylolpropionic acid, 0.63 g of 2,6-di-tert-butyl-p-cresol, 63.02 g of N-methylpyrrolidone, 143.13 g of isophorone diisocyanate, 556.98 g of tap water, 14.26 g of triethylamine and 7.70 g of ethylenediamine are used.

NCO content of the polyurethane prepolymer (theory): 3.65% by weight

A stable polyurethane dispersion having the following characteristics is obtained:

| Characteristic | Semitranslucent |
|---|---|
| Solids content | 38% by weight |
| Charge density | 37.10 meq · (100 g)⁻¹ |

Material properties of the polyurethane dispersions from examples A.1 to A.7 after drying under standard temperature and humidity conditions

| Example | A.1 | A.2 | A.3 | A.4 | A.5 | A.6 | A.7 |
|---|---|---|---|---|---|---|---|
| Tensile strength δ_{M} | 42.6 MPa | 46.8 MPa | 39.4 MPa | 33.6 MPa | 11.7 MPa | 48.8 MPa | 22.8 MPa |
| Elongation at break ε_{B} | 395% | 416% | 423% | 332% | 328% | 390% | 336% |
| König pendulum | 81 s | 71 s | 48 s | 69 s | 136 s | 110 s | 127 s |
| hardness | | | | | | | |

Material properties according to EN ISO 527 (application: 250 μm wet film thickness) König pendulum hardness according to DIN 53157 (application: 150 μm wet film thickness) Standard temperature and humidity conditions: drying for 7 d at 23° C. and 50% relative humidity

### EXAMPLES B

### Flexible and Postformable Coating Systems Based on Polyurethane Dispersions

| | | | |
|---|---|---|---|
| (1) | 500.0 | g | of polyurethane dispersion from example |
| | | | A.1 (binder) |
| (2) | 8.0 | g | of Acematt TS 100 (dulling agent) |
| (3) | 30.0 | g | of Dowanol DPnB (coalescence auxiliary) |
| (4) | 5.0 | g | of Byk-341 (deaerator) |
| (5) | 4.0 | g | of Byk-024 (antifoam) |
| (6) | 40.0 | g | of butylglycol (coalescence auxiliary) |
| (7) | 1140.0 | g | of polyurethane dispersion from example |
| | | | A.1 (binder) |
| (8) | 169.0 | g | of tap water |
| (9) | 10.0 | g | of Acrysol RM-8 (rheology additive) |
| (10) | 2.0 | g | of Byk-024 (antifoam) |
| (11) | 24.6 | g | of Darocur 1173 (photoinitiator) |
| | | | (α-Hydroxy-α-methylpropiophenone |
| | | | (HMEPK)) |

Sources:
(2) Degussa-Hüls AG
(3) Dow Chemical Europa SA
(4), (5), (10) Byk Chemie GmbH
(11) Ciba Spezialitätenchemie AG

### EXAMPLE B.2

### Base and Top Coat

The preparation was carried out analogously to example A.1.

500.0 g+1140.0 g of the polyurethane dispersion from example A.2 are used.

Material Properties of Flexible and Postformable Coating System from Example B.1 after Forced Drying and Radiation Curing by Means of UV-induced Free Radical Polymerization

| | Example | | | | |
|---|---|---|---|---|---|
| | A.1 | | | | |
| | Standard | | | | |
| | temperature | | | | |
| | and humidity | B. 1 | | | |
| Drying conditions | conditions | 5 min 50° C. | 10 min 50° C. | 5 min 80° C. | 10 min 80° C. |
| Tensile strength δ_{M} | 42.6 MPa | 37.2 MPa | 54.1 MPa | 58.3 MPa | 65.0 MPa |
| Elongation at break ε_{B} | 395% | 191% | 243% | 222% | 262% |

| | | |
|---|---|---|
| König pendulum | 81 s | 103 s |
| hardness | | |

Material properties according to EN ISO 527 (application: 250 μm wet film thickness)

König pendulum hardness according to DIN 53157 (application: 150 μm wet film thickness)

Radiation curing: High-pressure mercury lamp type IST-CK, 80 W cm⁻¹

Standard temperature and humidity conditions: drying for 7 d at 23° C. and 50% relative humidity (without radiation curing)

Material Properties of Flexible and Postformable Coating System from Example B.2 after Forced Drying and Radiation Curing by Means of UV-induced Free Radical Polymerization

| | Example | | | | |
|---|---|---|---|---|---|
| | A.2 | | | | |
| | Standard | | | | |
| | temperature | | | | |
| | and humidity | B.2 | | | |
| Drying conditions | conditions | 5 min 50° C. | 10 min 50° C. | 5 min 80° C. | 10 min 80° C. |
| Tensile strength δ_{M} | 46.8 MPa | 33.7 MPa | 55.6 MPa | 49.4 MPa | 62.3 MPa |
| Elongation at break ε_{B} | 416% | 202% | 249% | 200% | 263% |

| | | |
|---|---|---|
| König pendulum | 71 s | 93 s |
| hardness | | |

Material properties according to EN ISO 527 (application: 250 μm wet film thickness)

König pendulum hardness according to DIN 53157 (application: 150 μm wet film thickness)

Radiation curing: High-pressure mercury lamp 80 W cm⁻¹

Standard temperature and humidity conditions: drying for 7 d at 23° C. and 50% relative humidity (without radiation curing)

### EXAMPLE C

### Finished Products

The flexible and postformable coating systems from examples B.1 and B.2 are applied mechanically by spray coating in a coating amount of about 100 g·M⁻² (about 10 to 20 μm dry coat thickness) in two operations as base coat and top coat to various veneered wood boards (veneers: beech, oak, ash), subjected to forced drying at 80° C. for 5 min and 10 min, respectively, radiation cured (high-pressure mercury lamp type IST-CK, 80 W cm⁻¹, 800 to 1200 mJ cm⁻²) and then subjected to a direct postforming method.

The resulting finished products have smooth and crack-free surfaces with bending radii of 5 mm. The material properties correspond to examples B.1 to B.2.

1. A flexible and/or postformable coating system for veneered wood and further coating materials based on at least one polyurethane dispersion, which is obtainable by reacting
a) 25 to 250 parts by weight of a polyol component (A) comprising
a₁) 10 to 100 parts by weight of an unsaturated polymeric polyol (A)(i) having one or more double bonds capable of free radical polymerization and two or more hydroxyl groups and a molecular weight of 200 to 6000 dalton and/or 10 to 100 parts by weight of a polymeric polyol (A)(ii) having two or more hydroxyl groups and a molecular weight of 500 to 6000 dalton,
a₂) 2.5 to 25 parts by weight of a low molecular weight polyol component (A)(iii) having two or more hydroxyl groups and a molecular weight of 50 to 249 dalton,
a₃) 2.5 to 25 parts by weight of a low molecular, weight and anionogenic polyol component (A)(iv) having two or more hydroxyl groups and one or more inert carboxyl and/or sulfo group(s) and a molecular weight of 100 to 1000 dalton,
b) 50 to 250 parts by weight of a polyisocyanate component (B), comprising at least one polyisocyanate, polyisocyanate derivative and/or polyisocyanate homolog having two or more aliphatic and/or aromatic isocyanate groups,
c) 2 to 50 parts by weight of a polyamine component (C), comprising
c₁) 1 to 25 parts by weight of a tertiary amine and/or of an alkali metal hydroxide as neutralizing component (C)(i) and
c₂) 1 to 25 parts by weight of a polyamine having two or more primary and/or secondary amino groups as chain-extender component (C) (ii),
d) 0 to 100 parts by weight of a solvent component (D), comprising an inert organic solvent and/or a copolymerizable reactive diluent having one or more double bonds capable of free radical polymerization, and
e) 50 to 1500 parts by weight of water to give a solvent-free or low-solvent polyurethane dispersion and then further processing this by adding
f) if required, 0.5 to 50 parts by weight of a photoinitiator component (E) and
g) 0.5 to 500 parts by weight of a formulation component (F) to give the end product (postforming coating).

2. The coating system as claimed in claim 1, characterized in that the component (A)(i) is selected from unsaturated polyesterpolyols or other compounds which contain 100 to 1000 meq·(100 g)⁻¹ of double bonds capable of free radical polymerization and have an average molecular weight of 200 to 3000 dalton.

3. The coating system as claimed in either of claims 1 and 2, characterized in that the component (A)(ii) is selected from polyalkylene glycols, aliphatic and/or aromatic polyesters, polycaprolactones, polycarbonates, alkyd resins, reaction products of polyfunctional epoxy resins and unsaturated fatty acids, α, ω-polymethacrylate-diols α, ω-dihydroxyalkylpolydimethylsiloxanes, macromonomers, telechels or mixtures thereof.

4. The coating system as claimed in any of claims 1 to 3, characterized in that the photoinitiator component (E) is selected from compounds in which free radical formation is caused by homolytic cleavage (intramolecular cleavage) or by intermolecular hydrogen abstraction.

5. The coating system as claimed in any of claims 1 to 4, characterized in that the photoinitiator component (E) is an α-cleaver, such as benzoin ethers, benzil ketals, α, α-dialkoxyacetophenones, α-hydroxyalkylphenones or α-hydroxyalkyl aryl ketones, α-aminoalkylphenones, acylphosphine oxides, phosphine oxide ketals or an hydrogen abstractor (H abstractor), such as benzils, benzophenones or substituted benzophenones, thioxanthones or a mixture thereof.

6. The coating system as claimed in any of claims 1 to 5, characterized in that the formulation component (F) is an antifoam, deaerator, lubricating or leveling additive, radiation-curable additive, dispersant, substrate wetting additive, water repellent, rheology additive, such as a polyurethane thickener, coalescence auxiliary, dulling agent or optionally a filler, pigment or further additive in suitable combination and/or an aqueous or nonaqueous polymer or polymer composition.

7. The coating system as claimed in any of claims 1 to 6, characterized in that the solids content of the postformable coating system based on the components (A) to (F) is adjusted to 10 to 70% by weight.

8. The coating system as claimed in any of claims 1 to 7, characterized in that the solvent content of the postformable coating system based on the components (A) to (F) is adjusted to 0 to 10% by weight.

9. The coating system as claimed in any of claims 1 to 8, characterized in that the polyurethane dispersions based on the components (A) to (D) are capable of film formation on physical drying.

10. The coating system as claimed in any of claims 1 to 9, characterized in that the content of double bonds capable of free radical polymerization in the polyurethane polymer based on the components (A) to (C) or (A) to (D) when a reactive diluent is used is adjusted to 0 to 100 meq·(100 g)⁻¹, preferably to 30 to 50 meq·(100 g)¹.

11. A method for the production of a flexible and/or postformable coating system as claimed in any of claims 1 to 10, characterized in that
a₁) a premix is prepared from the components (A) and, if required, (D) and/or the components (A)(i), (A)(ii), (A)(iii), (B) and, if required, (D) are reacted in the presence of a catalyst to give a polyurethane preadduct, a₂) the premix from stage a₁) is reacted with the component (B), optionally stepwise, to give a polyurethane prepolymer and/or the preadduct from stage a₁) is reacted with the component (A)(iv),
a₃) the polyurethane prepolymer from stage a₂) is then neutralized, before or during the dispersing in water, with the component (C) (i),
a₄) the neutralized and dispersed polyurethane prepolymer from stage a₃) is then subjected to chain extension with the component (C)(ii),
a₅) the solvent-free or low-solvent polyurethane dispersion from stage a₄) is formulated with the components (E) and (F) in any desired sequence and
a₆) the solvent-free or low-solvent polyurethane dispersion from stage a₅) is combined with further aqueous polymer dispersions and/or other polymers.

12. The use of the coating system as claimed in any of claims 1 to 10 as a postforming coating for producing the system comprising base and/or top coat(s) for veneered wood and further coating materials.

13. The use as claimed in claim 12, characterized in that the further coating materials used are papers and/or cardboard boxes and/or plastics films and/or metal foils.

14. The use as claimed in either of claims 12 or 13, characterized in that one or more polyurethane dispersions based on the components (A) to (D) and, if required, further polymers and/or reactive resins are used as binders for producing the system comprising base and/or top coat(s).

15. The use as claimed in either of claims 12 and 14, characterized in that the application as base and/or top coat is effected in one or more layers in a total amount of 1 to 1000 g·m⁻² of the area to be coated and per operation.

16. The use as claimed in any of claims 12 to 15, characterized in that the application as base and/or top coat is effected in one or more layers with a total dry coat thickness of 5 to 500 μm.

17. The use as claimed in any of claims 12 to 16, characterized in that
b₁) the veneers and/or further coating materials are adhesively bonded to an optionally profiled blank and/or base material with suitable glues,
b₂) the prefabricated workpiece from stage b₁) is subjected to grinding and dedusting and is treated, optionally by application of deresinifying agents and/or brighteners and/or colorants and pickling agents and/or pore fillers and optionally by forced drying,
b₃) the polyurethane dispersion (postforming coating) from stage a₄), a₅) or a₆), optionally in combination with further polymers and/or reactive resins, is applied in one or more coats as base and/or top coat, optionally in pigmented form, to the workpiece from stage b₁) by casting, spray coating or roll-coating, optionally subjected to forced drying, optionally cured by means of UV-induced free radical polymerization and optionally subjected to a veneer grinding and dedusting and optionally these process steps are repeated, it being possible for the steps b₁), b₂) and b₃) to be carried out in any desired sequence,
b₄) the coated workpiece from stages b₁) to b₃) is subjected to a direct postforming method or a standard postforming method and finally
b₅) the finished shaped article from stage b₄) is cooled and stacked.

18. The use as claimed in claim 17, characterized in that, as an alternative to stage b₂), the radiation curing by means of UV-induced free radical polymerization is not effected until after stage b₄).

19. The use as claimed in claim 17, characterized in that, as an alternative to stage b₃), the application of the formulated polyurethane dispersion (postforming coating) from stage a₄), a₅) or a₆) is effected in two-component form in combination with suitable curing agents.

20. The use as claimed in any of claims 12 to 19, characterized in that, depending on the formability of the veneers or coating materials to be processed, bending radii of 1 to 100 mm, preferably 5 to 6 mm, are produced.

21. The use as claimed in any of claims 12 to 20, characterized in that, depending on the formability of the veneers or coating materials to be processed, the forming is carried out without steam treatment or moistening.

22. The use as claimed in any of claims 12 to 21, characterized in that postcuring is effected by self-crosslinking after forming is complete.

23. The use as claimed in any of claims 12 to 22, characterized in that the polyurethane dispersion from stage a₄), a₅) or a₆) is used as an adhesive for the adhesive bonding of veneers or further coating materials to any desired blank and/or base materials.

24. The use as claimed in any of claims 12 to 23, characterized in that the polyurethane dispersion from stage a₄), a₅) or a₆) is also used for lamination, encasing, membrane pressing technique, softforming on edge gluing machines, or forming of other materials, such as, for example, coated OSB boards.

25. The use as claimed in any of claims 12 to 24 as a base and top coat for veneered wood in the form of furniture, windows, strips, doors, casings, parquet flooring, veneered floors and further finished products, postforming elements and shaped articles of any desired geometry.

26. The use as claimed in any of claims 12 to 25, characterized in that the veneers are solid timbers based on beech, yew, spruce, pine, larch, fir, Weymouth pine, Swiss stone-pine, maple, birch, pear, oak, alder, ash, cherry, lime, walnut, poplar, plane, elm, Brazilian pine, abachi, afrormosia, afzelia, ebony/macassar ebony, limba, mahogany, makore, mansonia, okoume/Gaboon, padouk, East Indian palisander, Rio palisander, ramin, rosewood, sapelli/sapelli mahogany, sen, sipo, teak, wenge, whitewood or zingana/zebrano.

27. The use as claimed in any of claims 12 to 26, characterized in that the polyurethane dispersion (postforming coating) from stage a₄), a₅) or a₆) is used as the base coat and a one-layer or multilayer acrylic finish is used as the top coat.

28. The use as claimed in any of claims 12 to 27, characterized in that the blank and/or base materials are wood, woodbase materials of all kinds, plastics of all kinds, metals of all kinds, MDF, HDF or composite materials of all kinds.
